(19) United States
(12) Patent Application Publication
(10) Pub. No.: US 2013/0225367 A1
(43) Pub. Date: Aug. 29, 2013

(54) Method For Setting Shift Points in a Transmission or for Increasing the Torque of an Electric Drive Machine

(71) Applicant: Bernd Dietzel, Syrgenstein (DE)

(72) Inventor: Bernd Dietzel, Syrgenstein (DE)

(21) Appl. No.: 13/696,280

(22) PCT Filed: May 17, 2011
(86) PCT No.: PCT/EP2011/002426

§ 371 Date: Feb. 19, 2013

(30) Foreign Application Priority Data
Jun. 10, 2010 (DE) 10 2010 023 316.1

(51) Int. Cl. B60W 10/11; B60W 10/06

(52) U.S. Cl. CPC B60W 10/11; B60W 10/06
USPC 477/97

(57) ABSTRACT

The invention concerns a method for setting shift points in an automated shift transmission or an automatic transmission of a vehicle driven by a motor, whereas the shift points can be displaced towards higher engine rotational speeds by activation of a kick-down function.

A method according to claim 1, characterised in that
the kick-down function is activated by the driver by actuating a switch, if one or several of the following conditions are met:
   a gear above a predetermined gear is already engaged or being engaged;
   the vehicle has reached a predetermined speed after starting from standstill or during operation;
   the vehicle has travelled a predetermined distance after starting from standstill;
   a predetermined time has elapsed after starting the vehicle from standstill;
   the current roadway slope is greater than a predefined roadway slope;
   the current vehicle acceleration is greater than a predefined acceleration value of the vehicle;
   the current torque of the drive wheels is less than a predetermined drive torque of the drive wheels;
whereas conversely the kick-down function is not activated despite the actuation of the switch and/or despite the actuation of the accelerator pedal irrespective of the position of the accelerator pedal, if not at least one of the stated conditions is met.

The invention concerns a method for setting shift points in an automated shift transmission or an automatic transmission of a vehicle driven by a motor, whereas the shift points can be displaced towards higher engine rotational speeds by activation of the kick-down function. By automated shift transmissions are meant those transmissions, in which the gear is engaged as well as the clutch is opened or closed not by the driver, but by appropriate actuators. The method according to the invention can be used in vehicles only driven by a combustion engine, but also in other vehicles, in particular those which are driven by combustion engines but also electric motors—for instance in hybrid vehicles. In the latter, the invention concerns furthermore a method for increasing the torque of such an electric motor for driving the hybrid vehicle.

By kick-down function is meant the shift from upshift as well as switch-back (downshift) points towards faster engine speed to suit the driver's demand of performances by actuating an accelerator pedal, in particular in the area of the full load position of the accelerator pedal (full throttle) and/or an additional actuation of a switch for actuating the kick-down function. In the case of a hybrid vehicle, the kick-down function may have as a further consequence the increase of the torque of the electrical drive motor after a corresponding command of a specific performance by the driver, notably inasmuch as by means of the electrical drive motor an additional torque or an increased torque is added to the torque of an internal combustion engine, by means of which the hybrid vehicle is driven, (parallel hybrid) or inasmuch as the rotation torque of the electrical drive motor, i.e. the only torque driving the vehicle is increased (serial hybrid).

Modern automatic transmissions should assist the driver when selecting gears and direct his attention as far as possible to the manual diverting engagement of a gear according to the traffic situation, since the gear shift is conducted automatically to a vast extent. The driver can hence here have limited influence on the gear to be shifted directly. It should be guaranteed especially in risky situations, that the correct gear also corresponds to the vehicle performance or the vehicle acceleration demanded by the driver. For instance in case of overtaking situations, the performances requested by the driver must result in an increased tractive force or vehicle acceleration. This can be achieved in such a way: Should the driver request the vehicle to accelerate, the transmission control operates such that the gear engaged before the overtaking remains engaged longer, that the upshift points of the transmission are displaced towards higher rotation speeds (high-speed) or that the currently selected gear is reduced, so as to reach a higher torque at the vehicle wheels and hence a greater acceleration of the vehicle.

The displacement of the shift points by activation of the kick-down function towards higher engine rotational speeds involves increased fuel consumption, since greater power is required from the engine. Moreover, the kick-down function suspends all the fuel economy measures applied (mostly by the transmission control) such as for instance adaptation of the driver's style of driving, economy shift programmes and acceleration limits at least for the duration of the kick-down function. The suspension of these fuel economy measures is first of all for the sake of driving safety, so as to guarantee higher acceleration of the vehicle in case of danger, for instance precisely when the driver has overestimated oneself when overtaking and depressed the accelerator pedal fully. The kick-down function is therefore indispensable. Obviously, the same goes as well for the kick-down function of hybrid vehicles, by means of which additional torque of the electrical drive motor is made available.

However, the kick-down function is then provided according to the previous automatic transmissions or hybrid drives if the situation at hand is not dangerous or hardly, hence for instance during the starting cycles. This proves particularly disadvantageous in case of hectic driving of the vehicle driver, namely when the latter presses down the accelerator pedal permanently and especially in lower gears repeatedly in sequence and then fully up to the full load position (at full throttle).

These shortcomings tend to worsen in case of public short-distance traffic, such as for instance urban buses. For instance, the accumulation of starting and accelerating cycles, in particular in case of rush-hour traffic causes partially unintentional activation of the kick-down function by the driver, so that most economy shift programmes related to the itinerary profile are deactivated. In addition to the increased fuel consumption, the exhaust gas emissions also tend to rise, which can be in particular problematic when using such vehicles in city centres.

Document DE 602 09 622 T2 discloses a shift control device for continuously variable transmissions, with which the kick-down function is then only activated if the accelerator pedal position exceeds a threshold value. The threshold value is then preset dynamically according for instance to the roadway slope and the accelerator pedal position, whereas the kick-down function is then only actuated from a certain accelerator pedal position which exceeds the threshold value. The threshold value for activating the kick-down function will therefore increase for instance in case of an upcoming slope so that the accelerator pedal must be depressed “further” as this is the case on a level track, in order to activate the kick-down function. A strict switch-off of the kick-down function is however not provided. Said function is hence always activated for instance when depressing the accelerator pedal fully into the full load position. This is perfectly in line with the shortcomings described previously.

Another possibility consists in switching off the kick-down function using the software, for instance by modifying the parameters for activating the kick-down function. Such a reparametrisation however reduces the reliability of the kick-down function in operation, which may cause deactivation in a risky situation. Strict switch-off of the kick-down function is hence neither advisable nor desired.

The object of the invention is to provide a method for setting shift points in an automated shift transmission or an automatic transmission of a vehicle driven by a motor, which remedies the shortcomings of the state of the art. In particular fuel efficiencies, avoiding increased exhaust gas emissions, at the same time an increase of driving safety by providing the kick-down function in risky situations depending on the operating condition of the vehicle as well as optimal settings of the shift points shall be guaranteed by this method.

Besides, a method for increasing the torque of an electrical drive motor by means of a kick-down function shall be provided for a hybrid vehicle, the method avoiding the stated shortcomings.

The object of the invention is solved by a method as set out in independent claim 1 and by a method as set out in independent claim 2. The dependent claims represent preferred embodiments of the invention.

The inventors have found a solution in which the kick-down function is available, i.e. activated during operation of the vehicle exclusively under certain conditions and not available when said conditions are not met, i.e. is deactivated, whereas said conditions contribute equally to the safety of the vehicle driver as well as to the energy efficiency of the vehicle. In particular, in certain operating modes the applied fuel economy measures are preferred over the kick-down function, which means that the driver's request for switching on the kick-down function by actuating a switch or the accelerator pedal, is not taken into account, in particular when actuating the accelerator pedal—also repeatedly—into the end region of the accelerator pedal position (90 percent to 100 percent of the end region of the maximum possible accelerator pedal position at full throttle) to switch on the kick-down function and the kick-down function is not activated or remains deactivated. The kick-down function is not available and hence remains deactivated, despite the actuation of the switch and/or of the accelerator pedal and independently of the accelerator pedal position.

In a process according to the invention for setting shift points in an automated shift transmission or an automatic transmission of a vehicle driven by a motor, whereas the shift points can be displaced towards higher engine rotational speeds by activation of a kick-down function, the kick-down function is activated by the driver by actuating a switch and/or an accelerator pedal, the latter in particular in a predefined end region for instance of at least 90, 95 or 97 percent of the maximum possible accelerator pedal position at full throttle, if one or several of the following conditions are met:
a gear above a predetermined gear is already engaged or being engaged;
the vehicle has reached a predetermined speed after starting from standstill or during operation;
the vehicle has travelled a predetermined distance after starting from standstill;
a predetermined time has elapsed after starting the vehicle from standstill;
the current roadway slope is greater than a predefined roadway slope;
the current vehicle acceleration is less than a predefined acceleration value of the vehicle;
the current torque of the drive wheels is less than a predetermined drive torque of the drive wheels;
   whereas conversely the kick-down function is not activated despite the actuation of the switch and/or despite the actuation of the accelerator pedal irrespective of the position of the accelerator pedal, if not at least one of said conditions is met.

In accordance with an alternative method according to the invention for increasing the torque of an electrical drive motor in a hybrid vehicle by activating a kick-down function, the kick-down function is activated by the driver by actuating a switch and/or an accelerator pedal, the latter in particular in a predefined end region for instance of at least 90, 95 or 97 percent of the maximum possible accelerator pedal position at full throttle, if one or several of the following conditions are met:
a gear above a predetermined gear in a transmission of the hybrid vehicle transmitting drive power is already engaged or being engaged;
the vehicle has reached a predetermined speed after starting from standstill or during operation;
the vehicle has travelled a predetermined distance after starting from standstill;
a predetermined time has elapsed after starting the vehicle from standstill;
the current roadway slope is greater than a predefined roadway slope;
the current vehicle acceleration is less than a predefined acceleration value of the vehicle;
the current torque of the drive wheels is less than a predetermined drive torque of the drive wheels;
   whereas conversely the kick-down function is not activated despite the actuation of the switch and/or despite the actuation of the accelerator pedal irrespective of the position of the accelerator pedal, if not at least one of said conditions is met.

For instance, dealing with a hybrid vehicle which includes a parallel hybrid that means which is driven in parallel by an internal combustion engine and at least one electrical drive machine, as well as that which includes a serial hybrid, which is to say driven exclusively by the electrical drive machine, thereby the current for the electrical drive machine is made available in particular by means of an electric generator driven by an internal combustion engine.

With the current roadway slope, preferably a positive roadway inclination and consequently a hill is meant. The kick-down function is preferably activated for better climbing of a slope when driving up a mountain road. To do so, the whole mass of the vehicle as well as the optional additional load (for example a trailer) can be detected via corresponding sensors. With the current vehicle acceleration preferably a positive acceleration is meant, which causes forward motion of the vehicle, and not a negative acceleration, which occurs for example when braking.

The predetermined gear of the second forward gear of the transmission is particularly advantageous. The next higher one, i.e. the third gear could also be contemplated, from which the kick-down function is activated. The kick-down function is advantageously activated by actuating the switch and/or the accelerator pedal and if at least one of the stated conditions is met, in particular in the presence of a predetermined gear, and a downshift to a lower gear is prevented. Said function is applied in particular with a low gear for instance the second forward gear of the transmission. Here, downshifting to the next lower gear, i.e. to the first gear would bring no advantage, since said gear would strongly load the engine in terms of rotational speed and on the other hand the limit speed is reached rapidly for this gear.

The switch is particularly advantageous such coupled to an accelerator pedal of the vehicle that when the driver actuates the accelerator pedal, also the switch is actuated. In particular, the switch is activated only in an end region of the maximum possible accelerator pedal position (90 percent to 100 percent of the full throttle position of the accelerator pedal). The switch is advantageously built as a single-part with the accelerator pedal or placed opposite the accelerator pedal in such a way that it is actuated by the accelerator pedal. The actuating work is preferably determined, i.e. the product of the actuating force and of the actuating distance (difference in the accelerator pedal position before and after the actuation). A differentiation of both products is also possible so that on the one hand the actuating power or the momentum, the speed or the acceleration of the actuation are detected or calculated. To do so, corresponding sensors can be provided. Pressure transducers can also be contemplated.

The kick-down function is advantageously activated once a currently measured acceleration or a determined acceleration has been reached. The currently measured acceleration can for instance be captured by suitable sensors. Additional sensors can further be envisioned, for sensing a reference acceleration, from the parameters: vehicle mass, roadway inclination, rotational speed and rotating direction of a transmission output shaft or of the wheels as well as of the slippage between the wheels. For that purpose, appropriate sensors can be arranged as well on or in the transmission or in the drive train or even in the whole vehicle.

For instance, appropriate sensors can also detect the engine rotational speed or the engine torque as well as the currently engaged gear. A control unit can particularly advantageously be provided to carry out a method according to the invention, whereas said unit can be connected to a transmission control unit or be integrated therein. All or some of the sensors mentioned above can be in communication connection with the control unit via corresponding liner, i.e. be associated thereto. The control unit can also be connected to other control devices of usual vehicle assistance systems.

The limit values of the corresponding parameters of the conditions for activating the kick-down function (gear pitch, elapsed time, recorded distance, speed, acceleration, etc.) can advantageously be configured manually via an interface in the control unit in non-operation of the vehicle and adapted for instance to the place of use or to the operating conditions of the vehicle. Visualisation (monitors, displays) and input options (soft keys, keyboards) can also be integrated in the vehicle, which are connected to the interface of the control unit so that the driver can himself initiate suitable adaptations to the parameters stored in the control unit as well as to the limit values.

The invention will be described below using exemplary embodiments and the enclosed figures by way of example.

The figures are as follows:

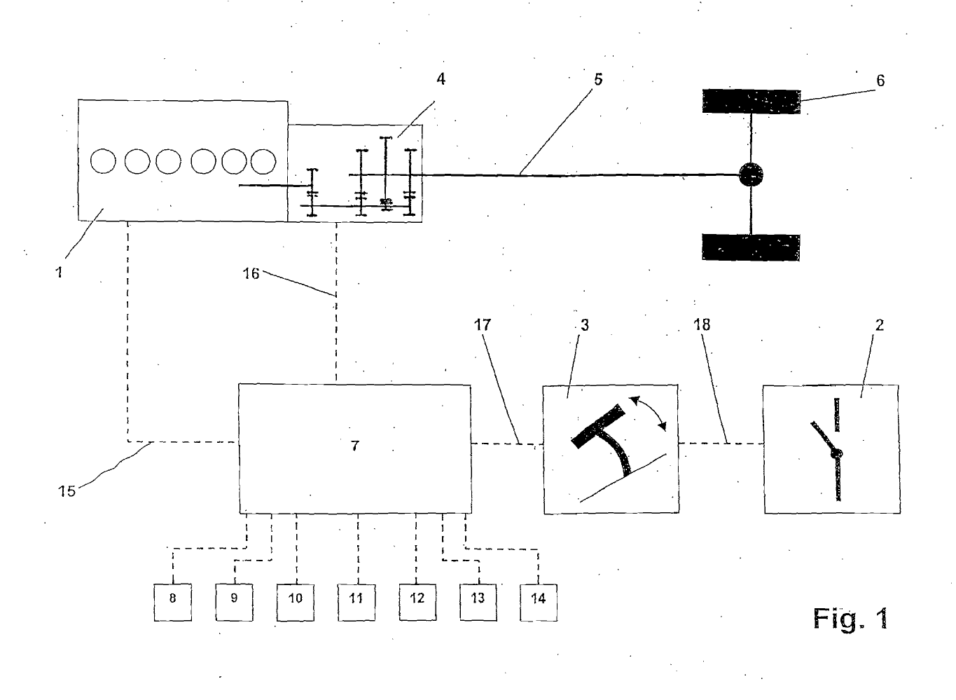

FIG. 1 is a diagrammatically simplified illustration of a drive train.

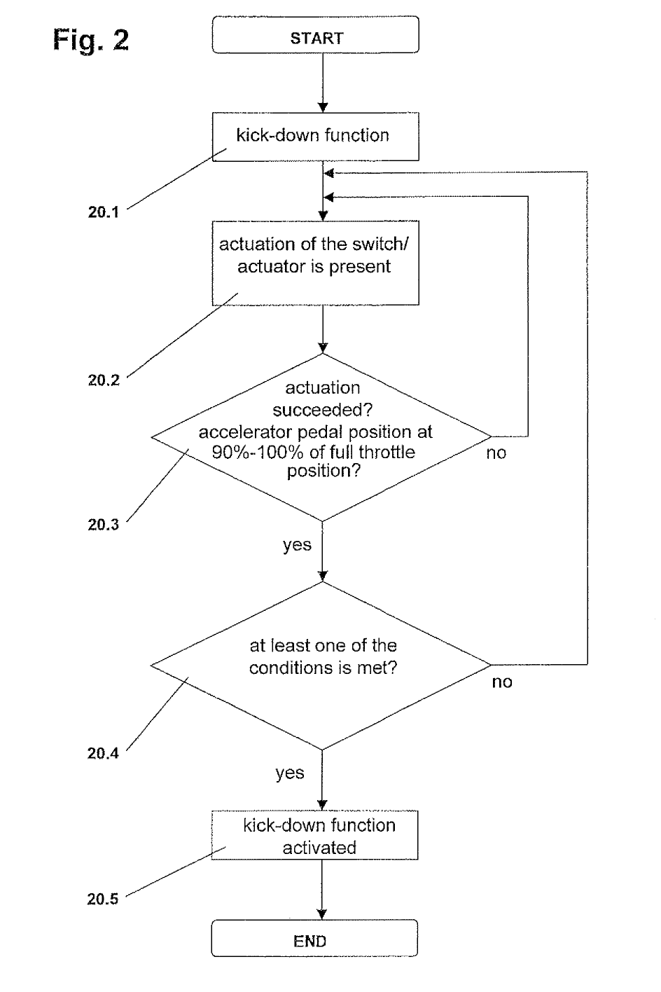

FIG. 2 is a block diagram of a method according to the invention for adjusting shift points.

FIG. 1 is a simplified diagram of the basic components of a vehicle drive train. Thereby, a transmission 4, in this instance an automatic transmission, is driven by an engine 1, in this instance arranged as an internal combustion engine. As regards the engine 1, it may be an electric motor, or one or several additional electric motors which can be drivingly connected to the transmission 2 via a transmission output shaft 5 with the wheels 6 of the vehicle. In this instance, the drive power generated by the engine 1 is transmitted via the transmission 2 and a transmission output shaft 5 to the wheels 6. A control unit 7 is further provided, which is connected via lines 15, 16, 17, 18 (dotted line) to the engine 1, the transmission 2, an accelerator pedal 3 as well as a switch 2 associated with the accelerator pedal 1 The control unit 7 comprises further a great number of sensors 8-14, whereas sensor 8 detects the currently engaged gear, sensor 9 detects the current speed of the vehicle and sensor 10 detects the current acceleration of the vehicle. Sensor 13 acquires in this instance the current drive torque, the rotational speed, the rotating direction as well as the slippage of the wheels, whereas conversely sensor 14 in this instance detects the current roadway slope. Further, a sensor 11 enables to determine the time after the start of the vehicle from standstill. Said sensor is consequently a counter in this instance. The comparison of a target time to the acquired time after starting from standstill through the sensor 11 enables to perform a target/actual comparison in the control device 7 and the kick-down function can be activated. A sensor 15 functions similarly, in this instance for registration of the distance travelled by the vehicle after starting from standstill. Here also, a reference value can be stored in the control unit for a travelled distance or be determined or calculated by said unit according to the actual operating conditions of the vehicle, with which the value captured by the sensor 12 is compared, whereas the kick-down function is activated if values match. It goes without saying that it is possible to determine the parameters illustrated in this instance as acquired by sensors or alternately by calculation from other acquired or calculated parameters as well, for saving individual or all illustrated sensors.

A signal line 15 from the engine 1 to the control unit 7 is representative of the detection of the operating states characterising the engine, such as for instance the current engine rotational speed, the engine torque as well as the ignition timings up to switching off individual cylinders, which pieces of information can be transmitted to the control unit 7. The control unit 7 can hence communicate (for example via CAN bus, bi-directionally) with the engine, transmission or various control devices, for instance usual vehicle assistance systems (ASR, TCS, ESP, ABS). The control unit 7 can also be built integrally with the mentioned control devices and in particular with the transmission control.

In this instance, the accelerator pedal 3 is coupled to the switch 2 or is in operative connection therewith, so that the position of the switch 2 is proportional to the accelerator pedal position, especially in the end region. The switch 2 can be a normal on/off switch or exhibit an infinite number of intermediate positions. The switch 2 can also be a valve, preferably a proportional valve. The switch 2 can also include devices for capturing the actuating pressure, the actuating acceleration, the actuating speed or the actuating travel of the switch 2 as well as of the accelerator pedal 3 coupled therewith. Additional sensors can also be envisioned here such as pressure transducers, optical, electronic, inductive as well as capacitive transducers.

FIG. 2 illustrates a flow chart for a method according to the invention for setting shift points in an automated shift transmission or an automatic transmission. The blocks 20.1-20.5 arranged between start and end are clearly visible. The block 20.1 designates the starting phase of the check, to know whether the conditions are met to trigger the kick-down function. In this instance, the limit values deposited in the control unit 7 and regarding the conditions can be read out of the control unit 7.

The actuation of accelerator pedal 3 or of the switch 2 is interrogated below in the block 20.2. In this instance, the check only wishes to establish whether the switch 2 or the accelerator pedal 3 has been actuated.

The block 20.3 adjoining the block 20.2 checks whether the actuation of the accelerator pedal 3 or of the switch 2 was successful, whether accelerator pedal 3 was consequently actuated in the end region of the maximal accelerator pedal position (90-100 percent) or was maintained by the driver in this area at least for a certain time. In this instance, an accidentally or unintentional actuation of the accelerator pedal up to the block can be filtered by the control unit by the duration of the actuation of the accelerator pedal in the full throttle position by means of a waiting period and hence the kick-down function can be made available accordingly or not. Also in that step of the method, the intensity of the actuation (actuating work), the actuating travel as well as the speed and the acceleration of the actuation can be captured and processed by appropriate sensors, as described in FIG. 1, by the control unit. According to said actuating parameters aforementioned, the system subsequently decides whether the actuation was performed successfully, if not, the system springs back between the blocks 20.1 and 20.2, whereas the system detects again whether the accelerator pedal 3 or the switch 2 was actuated.

If the actuation was performed successfully, the next method steps are carried out according to the following block 20.4. In so doing, the system checks whether at least one of the conditions of the method according to the invention is met. For that purpose, the sensors as well as additional control devices, as represented in FIG. 1, are interrogated. If at least one of said conditions is not met despite the actuation if the accelerator pedal 3 or of the switch 2, then the kick-down function is not activated, the system springs back to the start of the sequence and in this instance between the block 20.1 and 20.2.

If conversely at least one of the conditions is met, the kick-down function is actuated according to the next block 20.5 and in this instance the shift points of the transmission are displaced towards higher rotational speeds. In this instance, the sequence of the method is terminated subsequently.

### LIST OF REFERENCE NUMERALS

1 Motor
2 Switch
3 Accelerator pedal

4 Transmission
5 Transmission output shaft
6 Wheels
7 Control unit
8 Sensor
9 Sensor
10 Sensor
11 Sensor
12 Sensor
13 Sensor
14 Sensor
15 Line
16 Line
17 Line
18 Line
20.1-20.5 Block

1-7. (canceled)

8. A method for setting shift points in an automated shift transmission or an automatic transmission of a vehicle driven by an engine, whereas the shift points are displaced towards higher engine rotational speeds by activation of a kick-down function, characterized in that:
the kick-down function is activated corresponding to a driver's request by the driver by actuating a switch and/or an accelerator pedal, if one or several of the following conditions are met:
a gear above a predetermined gear is already engaged or being engaged;
the vehicle has reached a predetermined speed after starting from standstill or during operation;
the vehicle has traveled a predetermined distance after starting from standstill;
a predetermined time has elapsed after starting the vehicle from standstill;
the current roadway slope is greater than a predefined roadway slope;
the current vehicle acceleration is less than a predefined acceleration value of the vehicle;
the current torque of the drive wheels is less than a predetermined drive torque of the drive wheels;
whereas conversely the kick-down function is not activated contrary to the driver's request despite the actuation of the switch and/or despite the actuation of the accelerator pedal irrespective of the position of the accelerator pedal, if not at least one of said conditions is met.

9. The method according to claim 8, characterized in that the kick-down function is activated by actuating the switch and/or the accelerator pedal and if at least one of the stated conditions is met, in particular in the presence of a predetermined gear, and a downshift to a lower gear is prevented.

10. The method according to claim 8, characterized in that the switch is coupled to the accelerator pedal of the vehicle in such a way that also the switch is actuated in case the driver has actuated the accelerator pedal, in particular in an end region of the maximum possible accelerator pedal position.

11. The method according to claim 9, characterized in that the switch is coupled to the accelerator pedal of the vehicle in such a way that also the switch is actuated in case the driver has actuated the accelerator pedal, in particular in an end region of the maximum possible accelerator pedal position.

12. The method according to claim 8, characterized in that the kick-down function is activated in case when the current accelerator pedal position or the switch position lies in the range of 90 percent to 100 percent of the end region of the maximum possible accelerator pedal position or switch position at full throttle.

13. The method according to claim 9, characterized in that the kick-down function is activated in case when the current accelerator pedal position or the switch position lies in the range of 90 percent to 100 percent of the end region of the maximum possible accelerator pedal position or switch position at full throttle.

14. The method according to claim 10, characterized in that the kick-down function is activated in case when the current accelerator pedal position or the switch position lies in the range of 90 percent to 100 percent of the end region of the maximum possible accelerator pedal position or switch position at full throttle.

15. The method according to claim 11, characterized in that the kick-down function is activated in case when the current accelerator pedal position or the switch position lies in the range of 90 percent to 100 percent of the end region of the maximum possible accelerator pedal position or switch position at full throttle.

16. The method according to claim 8, characterized in that the kick-down function is activated once a currently measured acceleration or an obtained acceleration has been reached, whereas said value is calculated in particular from the vehicle mass, the roadway slope or the current engine torque.

17. The method according to claim 10, characterized in that the actuation speed, the actuation acceleration and/or the actuation pressure of the accelerator pedal and/or of the switch is detected and the kick-down function is activated above a defined limit value of the corresponding parameter.

18. A method for increasing the drive torque of an electric motor of a hybrid vehicle driven by the latter, whereas the torque is increased by activating a kick-down function, characterized in that:
the kick-down function is activated corresponding to a driver's request by the driver by actuating a switch and/or an accelerator pedal, if one or several of the following conditions are met:
a gear above a predetermined gear in a transmission of the hybrid vehicle transmitting drive power is already engaged or being engaged;
the vehicle has reached a predetermined speed after starting from standstill or during operation;
the vehicle has traveled a predetermined distance after starting from standstill;
a predetermined time has elapsed after starting the vehicle from standstill;
the current roadway slope is greater than a predefined roadway slope;
the current vehicle acceleration is less than a predefined acceleration value of the vehicle;
the current torque of the drive wheels is less than a predetermined drive torque of the drive wheels;
whereas conversely the kick-down function is not activated contrary to the driver's request despite the actuation of the switch and/or despite the actuation of the accelerator pedal irrespective of the position of the accelerator pedal, if not at least one of said conditions is met.

19. The method according to claim 18, characterized in that the kick-down function is activated by actuating the switch and/or the accelerator pedal and if at least one of the stated conditions is met, in particular in the presence of a predetermined gear, and a downshift to a lower gear is prevented.

20. The method according to claim 18, characterized in that the switch is coupled to the accelerator pedal of the vehicle in such a way that also the switch is actuated in case the driver has actuated the accelerator pedal, in particular in an end region of the maximum possible accelerator pedal position.

21. The method according to claim 19, characterized in that the switch is coupled to the accelerator pedal of the vehicle in such a way that also the switch is actuated in case the driver has actuated the accelerator pedal, in particular in an end region of the maximum possible accelerator pedal position.

22. The method according to claim 18, characterized in that the kick-down function is activated in case when the current accelerator pedal position or the switch position lies in the range of 90 percent to 100 percent of the end region of the maximum possible accelerator pedal position or switch position at full throttle.

23. The method according to claim 19, characterized in that the kick-down function is activated in case when the current accelerator pedal position or the switch position lies in the range of 90 percent to 100 percent of the end region of the maximum possible accelerator pedal position or switch position at full throttle.

24. The method according to claim 20, characterized in that the kick-down function is activated in case when the current accelerator pedal position or the switch position lies in the range of 90 percent to 100 percent of the end region of the maximum possible accelerator pedal position or switch position at full throttle.

25. The method according to claim 21, characterized in that the kick-down function is activated in case when the current accelerator pedal position or the switch position lies in the range of 90 percent to 100 percent of the end region of the maximum possible accelerator pedal position or switch position at full throttle.

26. The method according to claim 18, characterized in that the kick-down function is activated once a currently measured acceleration or an obtained acceleration has been reached, whereas said value is calculated in particular from the vehicle mass, the roadway slope or the current engine torque.

27. The method according to claim 20, characterized in that the actuation speed, the actuation acceleration and/or the actuation pressure of the accelerator pedal and/or of the switch is detected and the kick-down function is activated above a defined limit value of the corresponding parameter.
